(19) United States
(12) Patent Application Publication
(10) Pub. No.: US 2007/0259174 A1
(43) Pub. Date: Nov. 8, 2007

(54) Adherent thin film with leading edge identifying indicia

(76) Inventors: Michael Albanese, Belleville, NJ (US); Louis Scala, Apopka, FL (US)

Correspondence Address: BRADLEY N. RUBEN, PC, 463 FIRST ST, SUITE 5A, HOBOKEN, NJ, 07030, US

(21) Appl. No.: 11/879,294

(22) Filed: Jul. 17, 2007

Related U.S. Application Data
(63) Continuation of application No. 10/807,810, filed on Mar. 24, 2004, now abandoned.
(60) Provisional application No. 60/501,099, filed on Sep. 8, 2003.

(51) Int. Cl. B32B 7/12

(52) U.S. Cl. 428/345

(57) ABSTRACT

A film which may be a tape with a glue or a film with electrostatic cling properties and which is transparent, translucent, or opaque has an identifying indicia thereon in a pattern arranged such that the leading edge of the tape or film whether on the roll or separated from the roll in sections and used to wrap an item such as electrical tape for use in an electrical conductor splice is readily identified by misregistration of overlapping indicia at the leading edge with the next adjacent juxtaposed layer. Spliced conductors can also have their polarity identified by the color of the indicia.

This application is a continuation of application Ser. No. 10/807810, filed Mar. 24, 2004, now abandoned, which claims the benefit of U.S. provisional application Ser. No. 60/501,099 filed Sep. 8, 2003, the disclosures of which are incorporated herein by reference.

This invention relates to adhesive tape and static cling film rolls with indicia thereon.

Rolled adhesive tape, typically plastic thin film material, comprises a thin film coated on one or both sides with an adhesive coating. These tapes are available in different thicknesses depending upon application. Some tapes are available under the brand name “Scotch,” a registered trademark of Minnesota Mining and Manufacturing Company and other brands. Some tapes are transparent or clear, some translucent and others opaque. The opaque tapes may be a solid color. Certain tapes are used for packaging and may be clear or opaque, and others have surfaces on which to write with pen or pencil. Still other tapes are used in the electrical wiring industry.

These latter tapes are referred to as electrical tape and typically are opaque and are available commercially in different colors, typically black. These tapes are generally available as plastic film, but may be cloth or other materials. They are characterized by highly adherent coatings on one side. These tapes are used to cover bare electrical wires and typically are used to make splices, i.e., connect the bare ends of two or more wire conductors together to form an electrical conductive connection between the conductors forming a single continuous electrical wire. In one application, a cable may comprise a plurality of wire conductors, two or more. It is often required to interconnect such cables to form a continuous electrical conductor for each wire.

To form a continuous cable from two cables requires splices at the ends of each wire of the cable. This requires each conductor, e.g., hot, neutral and ground, for a typical three conductor AC cable, to be spliced to a corresponding conductor of the same polarity. Each such splice requires baring the end of the wires of the two conductors to be spliced together. The ends are mechanically connected as by twisting, soldering and so on. The interconnection of each wire is then wrapped with electrical tape.

This process is repeated for all three conductors so that the three wrapped interconnections of the conductors are juxtaposed with one another. A final step then wraps the three wrapped spliced ends together to form a single wrapped conductor bundle forming a wrapped cable section. Normally, all of these wrappings are made with the same tape, typically of the same solid color from a common roll of tape.

The problem with this arrangement comes at a later time when it is desired to separate the wires of the two cables at this wrapped junction. The problem becomes much more complex when the bundle consists of numerous wires such as in harnesses as used in communication systems, power systems employing multiple cables in a common cable line and so on. In some implementations, there may be tens or hundreds of single wires bundled together and spliced together at a single splice. Such wires in some instances may be spliced at a junction as multiple wire subassembly cables which subassembly cables are then wrapped together with the electrical tape to form a single cable.

Such electrical tape or any of the other tapes as described above are relatively thin, e.g., in the order of a few mils or even less than a mil. The tapes are wrapped, either about the roll in which they are supplied by the manufacturer or, in the case of the electrical tapes, about each other to form splices and so on. Being clear, translucent or even opaque and relatively thin, the free ends of the tape visually appear to merge with the rest of the tape body and become almost invisible to the eye of the ordinary observer.

All of the tapes are available in rolls where the tape sheet material is wound about a core about itself terminating in a free edge at the roll outer surface. Manufacturers, recognizing the problem with identifying the tape free ends on a roll, typically identify the free edge by attaching a piece of other material such as paper or the like so the user can identify this free edge.

The problem is that the user must remove this attached piece of material. It then becomes difficult, if not impossible, for the user to readily identify the free end of the tape, either on the roll in which tape is supplied or in the wrapped state such as in electrical wire splices as described below. One normally has to search in a time consuming effort, some times in vain, to locate the free end. This at times requires the user to create a new free end by cutting the outer layer(s) of the roll. This destroys at least some of the outer portions of the tape and is wasteful.

This problem is made worse in the case of electrical tape used to splice together a few wires, or tens or even hundreds of wires in a cable bundle when it is desired to remove the tape to expose the bare wires of the interconnections. Experience in the field has shown that finding the free ends of such tapes to unravel and remove them is extremely difficult. As a result to save time, cutting blades are used to remove the tape. This results in some of the wires inadvertently being cut or severed. In multiple wire bundles, it may not be readily apparent to the technician that one or more such wires are cut. The problem arises when the wires are reconnected and a cut wire is not noted when reconnected. It becomes a difficult and costly time consuming task then to make continuity checks on tens or hundreds of wires in a bundle to find the cut open wire.

Even in small splices involving fewer wires, finding the ends of the various wrappings of electrical tape is difficult and makes removing the tape and resplicing the tape without damage to the wires difficult. At times there is insufficient wire to resplice the ends if the wires are damaged which also makes the problem worse.

Other plastic sheet material is available as thin films which are referred to as static cling material. These sheets attach to each other by electrostatic forces rather than adhesive. These films may be a few mils or smaller in thickness. The films may be opaque, translucent or clear. They are typically used to wrap foods or enclosed containers, for example. These films exhibit the same problem described above with respect to tapes with adhesive coatings. The manufacturer may make the free end visible by forming crinkles in the end or attaching an element that makes the free end identifiable. But once the material is used, if the free end wraps about and clings to itself in the main roll, it becomes almost impossible to find. The user then generally has to destroy a portion of the roll in an attempt to create a new free end.

There has been a long felt need by commercial and consumer users of such materials with respect to these problems, which are, at least major time consuming and wasteful nuisances and, at worse, in the case of electrical tape or other applications, costly to fix.

While certain prior art sheet material have indicia thereon, this indicia is only for purposes of decoration of the material. Such sheet material such as paper towels and so on also do not have the edge identification problem of thin film tapes and static cling materials. Also thin film plastic bags may be available in rolls with decorations thereon. However, these decorations do not relate to the free end identification problem addressed above in connection with tapes and static cling films. The present inventors recognize a need to resolve the above problems with present thin film tapes and static cling films.

A thin film sheet material according to an aspect of the present invention comprises a length of thin film sheet material adhered to itself in a spiral roll of overlying multiple layers, the layers having a free end terminating at an edge on the outermost layer of the roll, the edge overlying the outer surface of the next adjacent radially inward layer and visually observable indicia arranged in a pattern on the sheet material wherein the pattern at the free end edge is misregistered with the pattern on the portion of the next adjacent radially inward layer to thereby make the free end edge visually observable.

According to one aspect, the pattern cyclically repeats along the length and according to further aspects, the material includes an adhesive coating on at least one side of the material, the material may be arranged to statically cling to itself, the material is thermoplastic, the film may be less than about 5 mils in thickness, the indicia is of one solid color, the film is electrical tape, the material is transparent, the pattern is a series of curves and more preferable, the pattern is sinusoidal or a series of straight lines or the lines are interconnected at an angle of at least one value forming a zig-zag line.

According to a further aspect, an electrical tape according to the present invention comprises a length of opaque electrically insulating sheet material of a uniform color adhered to itself in a spiral roll of overlying multiple layers, the layers having a free end terminating at an edge on the outermost layer of the roll, the edge overlying the outer surface of the next adjacent radially inward layer.

An adhesive coating is on one side of the material and a repetitive pattern having a color different than the uniform color extends along the length of the sheet material is visible thereon at a side of the material opposite the one side.

In a further aspect, the pattern is substantially continuous or may have repetitive discontinuous portions.

In a further aspect, the pattern comprises any one or combination of the group consisting essentially of straight lines, curved lines, circles, squares, ellipses, triangles, sinusoidal curves, zig-zag lines, lines angled relative to each other.

According to a still further aspect, an electrical adhesive tape comprises a spiral layer of electrically insulating sheet material of a first color formed into a spiral roll of the material, the material having an adhesive coating on one surface thereof and an indicia pattern thereon in a single second color different than the first color of the sheet material. Preferably, the second color is one of green, white and red.

A method of splicing an electrical cable formed of multiple wires according to the present invention comprises covering a spliced bared conductor end of each wire with an electrically insulating tape with a color corresponding to the polarity of the wire being spliced. Preferably the tape has a first color different than the color of said color corresponding to the polarity of the wire. Preferably the method includes covering the conductor end of a first wire with red electrical tape, the first wire for carrying a hot electrical signal, covering a second wire for carrying a ground signal with a green electrical tape, and covering a third wire for carrying a neutral signal with a white electrical tape.

In a further aspect, a method of forming tape comprising forming tape with a pattern thereon arranged so that the pattern at the leading edge of the tape is misregistered with the pattern of a layer of the tape next adjacent to and juxtaposed with the leading edge.

### IN THE DRAWINGS:

FIG. 1 is an isometric view of a prior art tape roll;

FIG. 1a is an isometric view of a portion of the tape of FIG. 1;

FIG. 1b is a side elevation view of a spliced electrical conductor according to the prior art;

FIG. 2 is a plan view of the roll of FIG. 1;

FIGS. 3a, 4a and 5a are plan views of different rolls of tape according to three respective different embodiments of the present invention wherein indicia of three different patterns according to the three embodiments of the present invention misregister at the free ends and are used to identify a free end of the tape on each roll of the different embodiments;

FIGS. 3b, 4b, 5b and 6b are respective plan views of portions of the rolled material of FIGS. 3a, 4a, 5a and 6a, the latter figures showing the free end edge with misregistered identifying indicia patterns of the corresponding rolled material of the respective rolls;

FIG. 6 is an isometric view of a prior art static cling plastic film roll;

FIG. 7 is an isometric view of a static cling plastic roll with a plurality of free end identifying indicia patterns similar to the pattern of FIG. 3b added to the roll of FIG. 6 wherein misregistration of the patterns at the sheet material free end edge readily identifies the free end;

FIG. 8 illustrates a pattern misregistration employing a zig-zag pattern of indicia according to a further embodiment of the present invention; FIG. 9 is a more detailed fragmented side elevation sectional view of the T-bar and yoke of FIGS. 5 and 6;

FIGS. 9-11 illustrate still further pattern embodiments of indicia to indicate the edge of a free end of a film roll;

FIG. 12 is an isometric view of a spliced multiconductor cable using an electrical tape according to the present invention for identifying the edge of the splicing tape;

FIG. 13 illustrates a side elevation view of a cable with the outer electrical tape removed to show the splicing tapes for three different conductors of the cable according to a further embodiment of the present invention;

FIG. 14 illustrates a side elevation view of a cable wire bundle that is spliced and enclosed with an electrical tape according to an embodiment of the present invention; and

FIGS. 15-30 illustrates representative still different pattern embodiments according to the present invention.

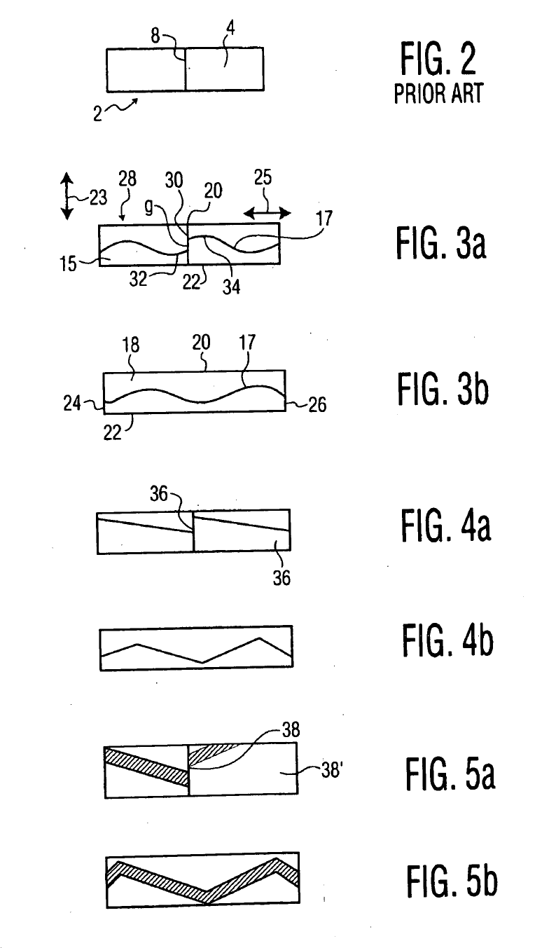

The term misregistration as employed herein means that the indicia of juxtaposed layers of film material at a free end edge, whether an adhesive tape or static cling, is misaligned transversely relative to each other at an edge of the material, e.g., edge 30, directions 23, FIG. 3a, or are discontinuous in a longitudinal direction, i. e,. circumferential direction, for rolled material, e.g., directions 25, FIG. 3a, about the periphery of a roll of material bearing such indicia. Transverse misalignment and discontinuity is illustrated in the indicia of FIGS. 3a, 4a, 5a and 6a. Transverse misalignment results in a gap g (FIG. 3a) or similar transverse displacement of the overlying indicia in directions 23 resulting in a misalignment between the overlying indicia lines at the edge 30 and discontinuity results in a line which is discontinuous with the line pattern in the longitudinal directions 25.

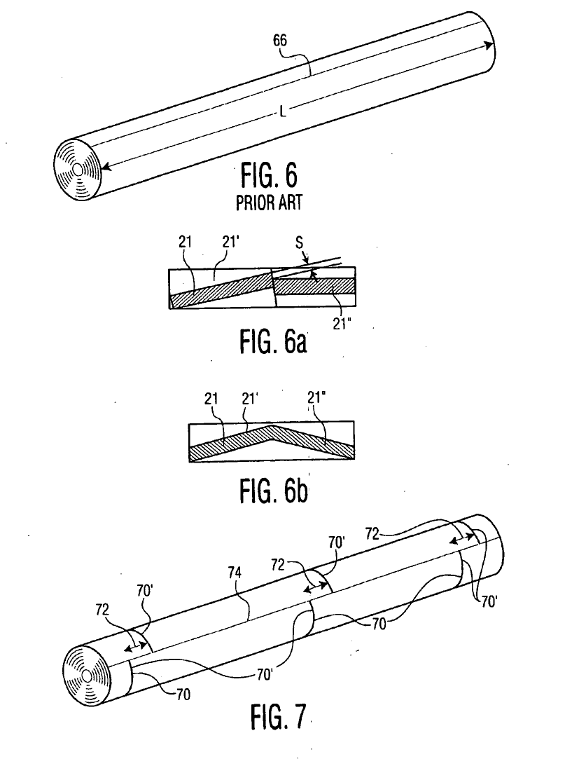

A single wide or narrow line(s) shows a discontinuity by a transverse shift of the line(s) relative to the circumferential direction of the line(s) (regardless if curved or straight—inclined, sinusoidal, zig-zag etc.) This is shown in FIG. 6a by a shift S in the zig-zag line 21 position at sections 21′ and 21″. In the alternative the same type of shift occurs in a sinusoidal line and so on. The pattern is preferably in the form of a continuous single line, but may be in other forms as shown below. In FIG. 3a, a continuous relatively thin sinusoidal line forming indicia 17 is shifted both transversely at edge 30 of the roll 28 of tape and is discontinuous in the circumferential directions 25 due to the misregistration. However, misregistration at an edge of the material may include either or both such conditions depending upon the pattern used. The preferred particular indicia pattern for a given application is one that readily reveals a misregistration by casual observation of the tape edge and may be determined empirically according to the type of tape (or static cling film) and its application.

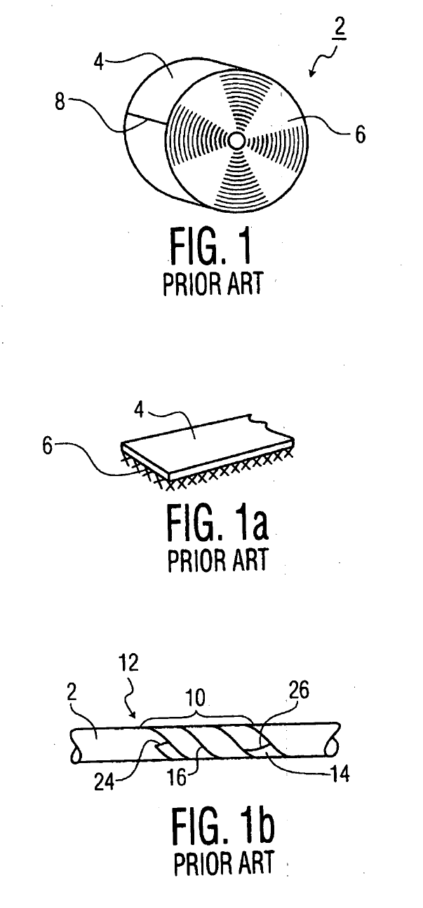

In FIGS. 1 and 1a, a spiral roll 2 of sheet material electrically insulating electrical tape 4 for example, or any other adhesive tape as may be applicable, comprises a sheet of thermoplastic or cloth or other electrically insulating material having an adhesive coating 6 on one surface thereof. The electrical tape 4 in this example is opaque and typically is sold commercially in solid black or other solid colors. This tape is typically used to splice electrical wires together as discussed in the introductory portion. The bare wires are twisted or soldered together to form a continuous electrical conductor. The joined wire junction is then covered by a spiraled covering 10, FIG. 1b, of the electrical tape 2. In multiple conductor cables, all such joints are then covered with further tape to join the connections into a single covered cable.

The problem with the tape 4 as discussed in the introductory portion is that the leading edge 8 of the tape on the roll 2, FIG. 1, or the leading edge 26 on the spliced joint 12, FIG. 1b, is difficult to visually locate. This is because the sheet material is relatively thin, and the solid color at the leading edge 26, FIG. 1b, of the free end merges with the color of the underlying juxtaposed layer 14 of the next adjacent layer of the roll 2. The edges 8 or 26 are almost invisible because of these factors. FIG. 1b is a simplified illustration as more complex joints use more conductors and layers and are more difficult to work with in respect of observing tape edges for removing the tape.

The same problem with the roll 2 thus occurs when the tape is used to cover a spliced electrical wire joint 12, FIG. 1b. The tape is spiraled over the joint so that the tape strip covers the length of the wire joint in overlapping layers, FIG. 1b, not too unlike that in the roll except that the tape covering is also exposed at its longitudinal edges 16 to the juxtaposed layers beneath the outer tape layer. Thus, there are a number of overlying edges of the tape exposed on the spliced joint and it is very difficult to observe readily the leading edge 26 of the splicing tape layers in order to remove the tape at its leading edge. This often may require cutting the tape in a medial region as explained more fully above introducing the problem discussed damaging the underlying wire during this cutting process.

A solution to this problem is providing the tape material with indicia as shown in FIGS. 3b, 4b and 5b by way of example. In FIG. 3b, the indicia 17 is a sinusoidal line of contrasting color to the underlying tape. The indicia 17 is located on the length of the strip 18 portion of solid color opaque sheet thermoplastic material tape 15 forming the roll 28. This strip portion represents the entire roll of tape. The strip portion 18 has end edges 24 and 26. The indicia 17 in this case is a sinusoidal line and located generally medially between the longitudinal side edges 20 and 22 of the tape 15 strip and extends from one longitudinal end edge 24 to the other longitudinal end edge 26 of the strip portion 18. The width of the line is not important, but a thinner line will tend to be more readily observable as being misregistered than a very wide line. The thin line will almost be always totally misregistered whereas a wide line while being misregistered may have a portion overlapping at the edge with the underlying line for a portion of the line width and thus may not be always immediately observable as being misregistered. The wider the line the more difficult it might be to observe the misregistration. What is desired is that the misregistration be immediate observed visually with only a casual examination of the tape or static cling material.

The strip portion 18 of FIG. 3b is a portion of the roll 28, it being understood that this is representative of the entire tape length. That is, the indicia 17 extends for the full length of the tape 15 of the roll longitudinally end edge to end edge (not shown) and as represented by end edges 24 and 26 of portion 18.

The indicia may be placed on the tape by-any known imprinting technique. Commercially available printing techniques imprint indicia on plastic sheet films such as bags and other articles. The printing may be by printing inks, electrostatic deposition, etching, molding or any other know process by which indicia is formed on or within the body of thin films. The printing may be by molecular action as well. The present invention is applicable to thin films that have leading edge identification problems and not to thick sheet materials. These latter materials, such as paper towels, shelving materials and the like, have edges that are readily identifiable by the thickness of the material and which may have decorative indicia thereon, whose purpose is solely for decoration.

The width of the indicia 16 of the tape 15 transverse to the longitudinal axis of the tape length is optional and may have any desired value. It should however, be sufficiently wide to be readily observable by the eye of an observer. A narrow line is preferable in that misregistration of the line at the leading edge 30, FIG. 3a, on the roll 2 is more readily observed with slight misregistration of the sinusoidal line of indicia 16 than a wider line. A sinusoidal or zig-zag line is preferable. The purpose of the indicia is to provide misregistration of the pattern portion 32 at the edge 30 as compared to the pattern portion 34 of the underlying next adjacent portion of the tape roll layers. This misregistration readily identifies the leading edge. As can be seen in FIG. 3a, the pattern portions 32 and 34 on the roll are separated by a gap g. This gap is readily observed by mere casual examination of the roll of tape 2.

When the strip portion 18 is removed from the roll and attached to a spliced wire such as at joint 12 to cover the joint between the wires, it appears as shown in FIG. 14. Here, the strip portion 18 is spiraled about the bare wires that are mechanically interconnected. The longitudinal side edges 20 and 22 overly the next adjacent under layer of the strip portion 18. In addition, the free end leading edge 26 overlies the next adjacent under layer 27. These overlying layers form almost invisible and difficult to detect edges 22 and 26 and especially leading edge 26.

However, the leading edge 26 indicia 17′ is misaligned and misregistered with the indicia 17″, FIG. 14, by an amount formed by gap g′. This gap g′ readily identifies to the user the edge 26. Thus the gap g′ is somewhat similar to the gap g on the roll 2 of FIG. 3a. It does not matter where the leading edge is cut from the roll of tape. It is statistically rare for the same pattern to overlap identically in a spliced tape. While such overlap might occur some times, it is believed to occur sufficiently rarely so as to make the principle of misregistration satisfactory for most uses as might be encountered in practice.

By making the indicia line relatively wide, the misregistration might occur only with a portion of the line at the adjacent edges. This is acceptable because such misregistration of overlying indicia lines is also readily observable by a careful review of the lines.

A line or lines is preferable to other patterns such as polka dots or similar numerous arrays of spaced elements in that the detection of the misregistration may become difficult in the ability to observe the misregistration in the presence of such numerous spaced elements. The misregistration of a single or few lines is easier to observe than hundreds of small or large spaced elements such as dots or other discrete elements which tend to be confused with the misregistered elements and thus require a high degree of care in observing the edge misregistration. If dots are used for example, they should be aligned in a linear array to emulate a line pattern. Thus misregistration of the dots can be observed by observing the corresponding line patterns formed by the dots. Spaced indicia such as dots and the like thus should also be sufficiently closely spaced to each other to manifest a line which they form.

FIGS. 4a, 4b and 5a, 5b show examples of zig-zag indicia lines, which manifest a sinusoidal line, of different widths and which also show misregistration of the leading edge to the juxtaposed layer there beneath in a roll of tape or static cling film material. The same principles occur during use as a splicing mode as discussed above in connection with FIG. 14. The misregistration of FIGS. 4a and 5a at gaps 36 and 38 in the zig-zag lines of the indicia 36′ and 38′, respectively are readily observed by casual examination, either in the roll format or when used in a splice format corresponding to FIG. 14. A mismatch of the pattern will occur most times at the leading edge of the top most layer when superimposed over another layer for each embodiment.

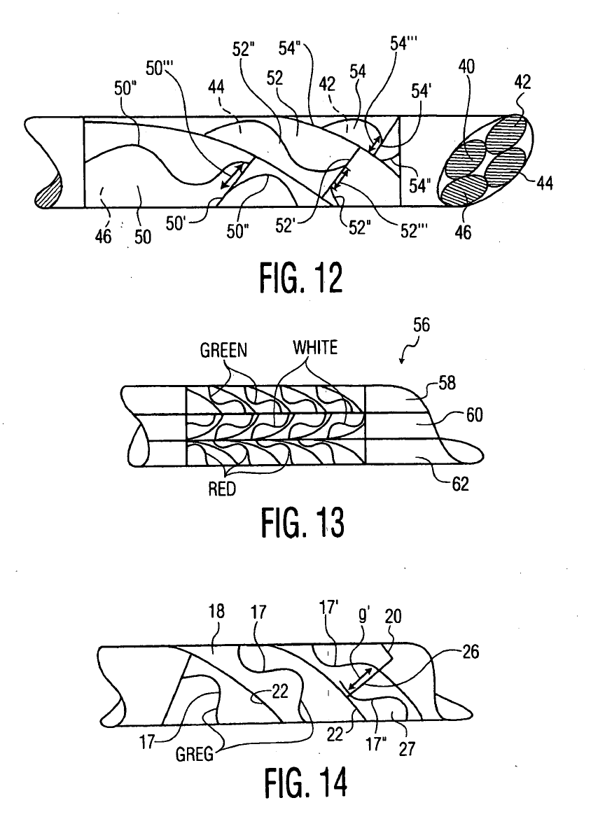

FIG. 12 shows spliced conductors 40, 42, 44, and 46 of a cable 48. Conductor 46 is spliced and covered with electrical tape 50, spliced conductor 44 is covered with tape 52 and conductor is covered with tape 54. Tape 50 has a leading edge 50′, tape 52 has a leading edge 52′ and tape 54 has a leading edge 54′. Tape 50 has indicia 50″, tape 52 has indicia 52″ and tape 54 has indicia 54″. These are shown misregistered at gaps 50″′, 52″′ and 54″′. These gaps in the indicia show misregistrations which are readily observable and this identify the leading edges of the tape used to cover each conductor.

FIG. 13 shows an arrangement similar to that of FIG. 12 except a three conductor cable 56 is shown wherein each conductor 58, 60, and 62 is spliced with a tape having an indicia sinusoidal line of a different color. The indicia line of the hot conductor is red, the indicia line of the neutral conductor is white and the indicia line of the ground conductor is green. Thus when it comes time to identifying which conductor is which as to polarity, the splicing tape color coded indicia readily identifies the polarity as well as the tape leading edge. When it comes time to remove the splice covering tape, the edges are readily identified and also the polarity of each conductor is readily identified. This takes the guess work out of reworking such splices as occurs in the prior art.

FIG. 6 shows a prior roll 64 of clear or colored plastic static cling film. This is supplied in rolls of different axial lengths L. The leading edge 66 is almost impossible to identify because this film is thin, e.g., less than 1 mil and because it readily sticks to the next adjacent layer with high tenacity.

FIG. 7 shows a roll 68 of similar film with a set of three spaced sinusoidal indicia lines 70. The lines 70′ at the leading edge 74 are misregistered with the lines of the next adjacent juxtaposed layer by gaps 72. These gaps readily identify the location of the edge 74. It does not matter where the material is torn from the roll, statistically, the lines 70 will misregister at most times with the next adjacent layer lines and readily identify the leading edge location.

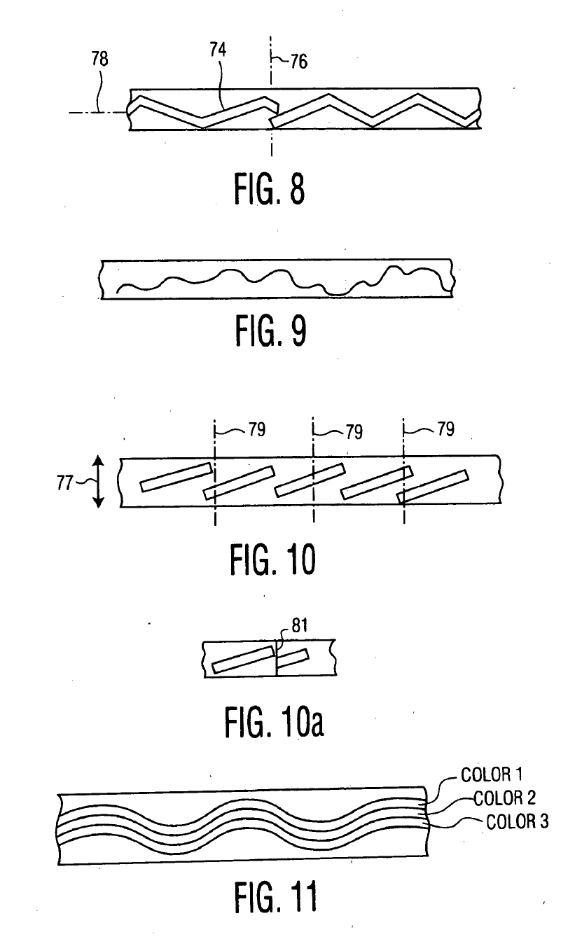

FIGS. 8-30 show various indicia patterns that may be used to identify leading edges of a roll of sheet material, whether adhesive or plastic static cling type. These edges are identified whether the material is on the roll or removed from the roll and wrapped about a cylindrical member in overlying relationship as discussed above.

FIG. 8 shows a zig-zag line 74 which is discontinuous at plane 76. However, line 74 overlaps in the transverse direction normal to longitudinal axis 78 in plane 76. Any misregistration in which there are no overlaps of the indicia lines in the transverse plane identifies the location of the leading edge. This is seen also in the FIG. 10 embodiment. However, it should be appreciated that small discontinuities in the indicia line may be present, e.g., dashed or dotted lines arranged in a linear array, and still be sufficient to identify the leading edge of the material due to major misregistration readily distinguishable from such discontinuities. However, these patterns are not preferred as compared to a continuous line which is readily observable as being discontinuous without a high degree of careful observation.

FIG. 9 shows an irregular sinusoidal type of indicia line.

FIG. 10 shows parallel diagonal lines which exhibit overlap in the transverse directions 77 at planes 79. Misregistration occurs at an edge such as edge 81 when a discontinuous line occurs with no over lap as shown in FIG. 10a. However such diagonal lines are not as good as a sinusoidal or zig-zag line wherein not only does misregistration occur with transverse displacement, it also occurs by a change in orientation between the overlying patterns at the edge. It is better to provide clear demarcation of the edge by clear changes in the pattern using relatively casual observation rather than requiring a need for a careful review as would occur in multiple discreet patterns such as polka dots and the like.

FIG. 11 shows three different discrete sinusoidal lines that are adjacent to each other.

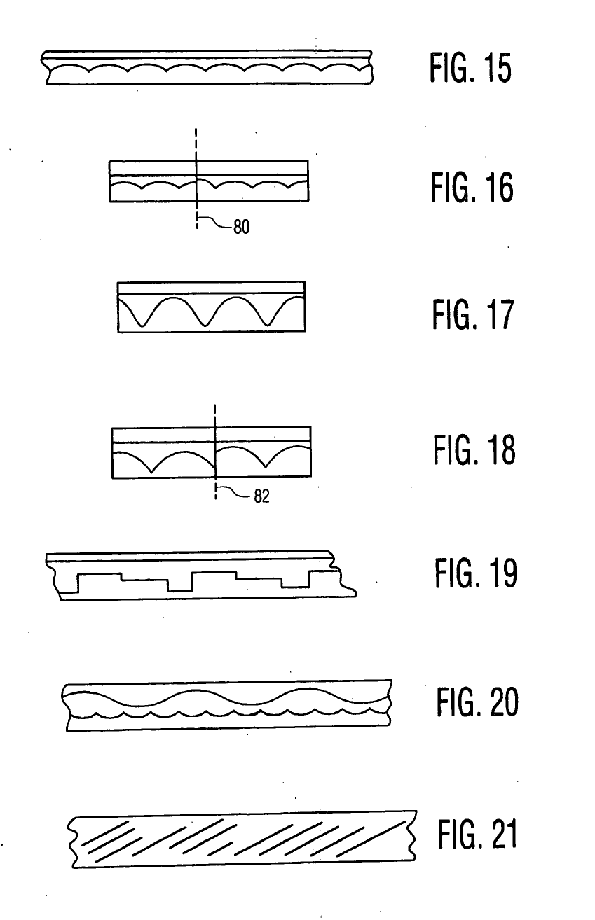

FIGS. 15 and 17 show similar straight line and spaced scalloped line patterns and FIGS. 16 and 18 show corresponding respective leading edges due to misregistration of these patterns in respective planes 80 and 82. the space between the lines may be a solid color for example such that the lines form edges of the pattern. In the alternative, the lines may be discrete.

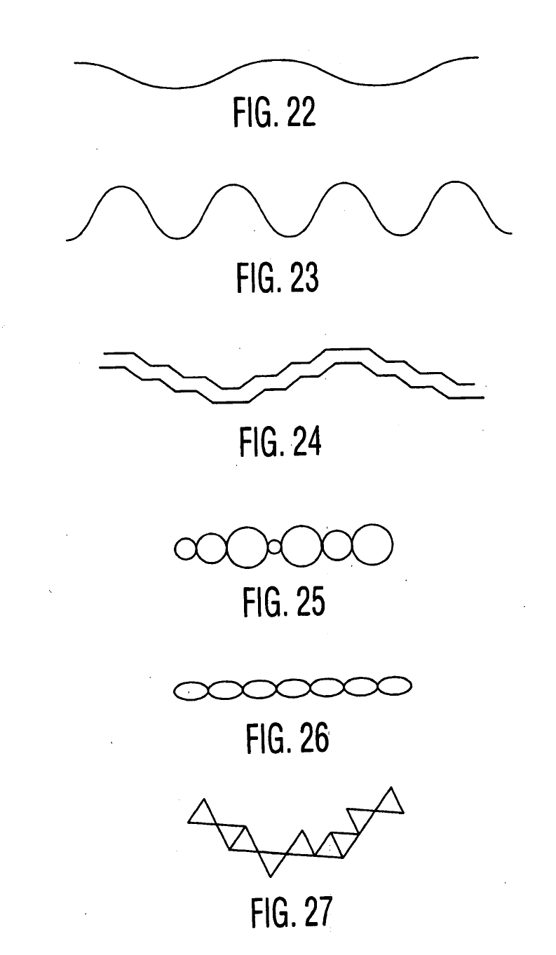

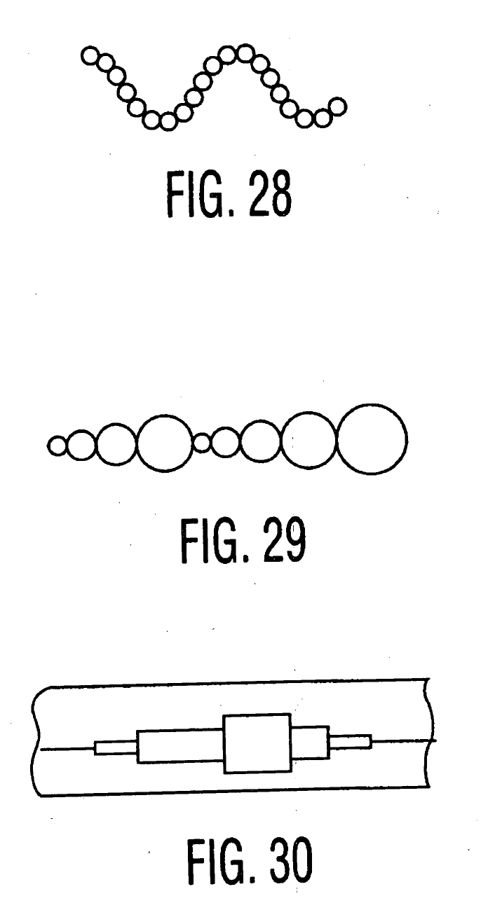

The remaining figures all show various patterns that will produce misregistration of the indicia patterns at the leading edges of tape or film when overlapped with a further tape or film layer. FIG. 19 illustrates a straight longitudinal line spaced from a stepped line manifesting various spaces from the straight line. FIG. 20 shows a sinusoidal line spaced from a scalloped line. FIG. 21 shows a plurality of spaced diagonal lines of different lengths. FIGS. 22-24 show different sinusoidal lines. FIGS. 25-29 show patterns comprising an arrangement of adjacent geometric figures such as circles (FIGS. 25 and 28), ellipses (FIG. 26 and 29), and triangles (FIGS. 27). FIG. 30 shows different rectangles and lines interconnected serially to form a pattern. All of the above patterns repeat in cycles on the tape from edge to edge along the tape length. More than one pattern may also be used on a single tape or sheet material. The patterns preferably are arranged aligned continuously in diagonals or sinusoidal or other curves whether or not symmetrical. As noted above, thinner indicia lines are preferred as well as continuous lines. But variations of these may be used as desired as discussed above.

It will occur to those of ordinary skill that the disclosed embodiments may be altered to provide still further embodiments, the invention being not limited to the disclosed embodiments. It is intended that the invention be defined by the appended claims.

For example, all types of films and tapes may be identified with the disclosed indicia whether for electrical, medical, mechanical or general household use. The films or tapes are adheringly attached to one another. It does not matter if an adhesive or electrostatic force is used to attach the film to itself or other elements. The term indicia refers to all kinds of marks whether or not on the film surface or embedded in the material. The term “on” the material thus refers to both on the surface and within the material interior. The term “continuous pattern” means a pattern such as a line or its equivalent such as spaced elements as discussed hereinabove, which pattern is continuous on the material for at least a major portion of the usable length of the material.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A roll of plastic electrically insulating tape comprising:
an unscored length of plastic electrically insulating sheet material having a first side and a second side, and releasably adhered to itself in a spiral roll of overlying multiple layers, the layers extending from a first end interior the roll to a second free end overlying the first side of the next adjacent radially inward layer of material;
an adhesive coating on the second side of the material overlying the adjacent radially inward layer; and
a pattern on the first side comprising
at least two lines, each having a color different than that of the first side of the sheet material on which each respectively line lies,
the two lines forming said pattern being disposed so that both lines are intersected by an edge transverse to said length between the first and second ends, and the lines being misregistered at said edge with the pattern on the first side of the next adjacent radially inward layer of material, and
said pattern extending substantially continuously from said first end to said second end;
the pattern effective to locate an end of a desired length of said tape for unwrapping said tape after said desired length of tape has been removed from said roll and wrapped around an object.

2. The tape of claim 1, wherein one of the lines is dashed or dotted.

3. The tape of claim 1, wherein the pattern at the edge is discontinuous with the pattern on the juxtaposed surface of the next adjacent radially inward layer of the roll of tape.

4. The tape of claim 1, wherein the pattern comprises lines forming any one or combination of the group consisting essentially of straight lines, curved lines, circles, squares, ellipses, triangles, sinusoidal curves, zig-zag lines, lines lines angled relative to each other, and combinations thereof.

5. The roll of claim 1, wherein the at least two lines each has a color different than the other, both of said colors different than the color of said first surface of the tape.

6. An adhesive-backed electrically insulating plastic tape comprising:
an unscored length of electrically insulating plastic sheet material of a first solid color formed into a spiral roll having opposing ends, the plastic sheet material having an adhesive coating on one surface thereof effective to be releasably adhered to itself; and
an indicia pattern on the opposite surface of the sheet material, said pattern comprising a at least two lines both extending between said opposing ends along substantially the entirety of said length, each line being a color different than the first solid color of the sheet material and effective to locate an end of said unscored length for unwrapping after said unscored length has been removed from said roll and wrapped around an object.

7. The tape of claim 6, wherein the at least two lines are the same color, said color being selected from the group consisting of green, white and red.

8. The tape of claim 7, wherein the two lines have different colors, one of said colors being green, white, or red, and the other color not being green, white, or red.

9. The roll of claim 1, wherein one of said two lines is curved and the other of said two lines is straight or consists of straight line segments.

10. The tape of claim 6, wherein one of said two lines is curved and the other of said two lines is straight or consists of straight line segments.
